(19) United States
(12) Patent Application Publication
(10) Pub. No.: US 2002/0056742 A1
(43) Pub. Date: May 16, 2002

(54) Methods and systems for attaching substrates to one another using solder structures having portions with different melting points

(76) Inventor: Glenn A. Rinne, Apex, NC (US)

Correspondence Address: MYERS BIGEL SIBLEY & SAJOVEC, PO BOX 37428, RALEIGH, NC, 27627, US

(21) Appl. No.: 10/016,000

(22) Filed: Nov. 2, 2001

Related U.S. Application Data
(60) Provisional application No. 60/246,898, filed on Nov. 10, 2000.

(51) Int. Cl. B23K 31/02; B23K 35/24

(52) U.S. Cl. 228/226; 228/230; 228/9

(57) ABSTRACT

A first substrate is attached to a second substrate by providing solder structures that include a first portion adjacent the second substrate that has a first melting point, and a second portion adjacent the first substrate that has a second melting point that is lower than the first melting point. The solder structures then are heated to a first temperature that is at or above the second melting point but below the first melting point, to melt the second portions. Simultaneous with the heating of the solder structures to the first temperature, the first substrate is attached to the second substrate while the second portions are melted. Finally, the solder structures are heated to a second temperature that is above the first temperature, to alloy at least some of the first portions and the second portions. Accordingly, low temperature joining and/or positioning of the first substrate relative to the second substrate may be performed, followed by conversion of at least part of the solder structures to a higher melting point alloy, thereby allowing a reduced creep rate.

### CROSS-REFERENCE TO PROVISIONAL APPLICATION

This application claims the benefit of Provisional Application Serial No. 60/246,898, filed Nov. 10, 2000, entitled In-Situ Adjustment of solder Bump Melting Points, the disclosure of which is hereby incorporated herein by reference in its entirety as if set forth fully herein.

### FIELD OF THE INVENTION

This invention relates to micro-miniature packaging systems and methods, and more particularly to systems and methods for positioning substrates relative to one another.

### BACKGROUND OF THE INVENTION

Solder bump technology is widely used for electrical and/or mechanical interconnection of substrates. As used herein, substrates can include microelectronic substrates such as integrated circuits and second- or third-level packaging substrates such as printed circuit boards; electro-optical substrates such as substrates including a light emitting diode or laser; optical substrates including a mirror or grating; and sensor substrates that include a sensor. For example, an integrated circuit chip, mirror or laser may be connected to a circuit board or other next level packaging substrate using solder bumps. This connection technology also is referred to as “controlled collapse chip connection-C4” or “flip-chip” technology, and will be referred to herein as solder bumps. Solder bump technology is described, for example, in U.S. Pat. Nos. 6,117,299, 5,892,179 and 5,381,946, the disclosures of which are hereby incorporated herein by reference in their entirety as if set forth fully herein, and need not be described further herein.

When solder bump technology is used to attach a first substrate to second substrate, the attachment generally takes place while the solder bumps are in a liquid state. Moreover, the first and second substrates may be positioned relative to one another, while the solder bumps are in a liquid state. The solder bumps then can be allowed to solidify, so that the first and second substrates may be maintained relative to one another in a desired position. Precise positioning may be desirable, for example, when at least one of the first or second substrates includes an electro-optical element such as a light-emitting diode and/or laser, or an optical element such as a mirror. When positioning these substrates, it may be desirable to precisely position the electro-optical or optical element to establish a precisely defined optical path. It also may be desirable to have all the bumps contact the first substrate, notwithstanding nonplanarity of the second substrate and/or variable size of the bumps.

Unfortunately, the high melting point of conventional solder bumps may make it difficult to retain the desired positioning. In particular, the large temperature change from the melting point of the solder back to room temperature or the device operating temperature can cause changes in position due to dissimilar thermal expansivity of the first and second substrates and/or the solder bumps. Moreover, the high solder bump melting points may degrade the performance of electro-optical or optical elements. For example, when a solid-state laser is used, high temperatures may cause impurities in the laser to become thermally ionized, and thereby degrade the lasing function. Accordingly, it may be desirable to use low melting point solders.

Unfortunately, low melting point solders such as indium solder, with a melting point of about 156° C., may have higher creep rates than high melting point alloys, such as a 30Pb-70In alloy. Accordingly, long term positional tolerance and/or reliability may be impacted when using low melting point solders compared to higher melting point solders.

### SUMMARY OF THE INVENTION

Embodiments of the invention attach a first substrate to a second substrate by providing a plurality of solder structures that include a first portion adjacent the second substrate that has a first melting point, and a second portion adjacent the first substrate that has a second melting point that is lower than the first melting point. The solder structures then are heated to a first temperature that is at or above the second melting point, but below the first melting point, to melt the second portions. Simultaneous with the heating of the solder structures to the first temperature, the first substrate is attached to the second substrate while the second portions are melted. Finally, the solder structures are heated to a second temperature that is above the first temperature, to alloy at least some of the first portions and the second portions. Accordingly, low temperature joining and/or positioning of the first substrate relative to the second substrate may be performed, followed by conversion of at least part of the solder structures to a higher melting point alloy, thereby allowing a reduced creep rate.

In some embodiments of the invention, the solder structures are allowed to cool to below the second melting point after the attachment and/or positioning is performed and before heating to the second temperature. Moreover, in some embodiments, the heating of the solder structures to the first temperature is performed for a first time interval, whereas the heating of the solder structures to the second temperature is performed for a second time interval that is less than the first time interval. Accordingly, the alloying may not disturb the positioning that already has been obtained. Moreover, in still other embodiments, the heating of the solder structures to the first temperature comprises heating the solder structures to the second melting point. In other embodiments, the heating the solder structures to the second temperature comprises heating the solder structures to a temperature that alloys the first and second portions. In yet other embodiments, the heating the solder structure to the second temperature comprises heating the solder structures to the first melting point.

In some embodiments of the invention, the alloying takes place using solid-state diffusion, without melting the second portions. In these embodiments, the solder structures are heated to the second temperature, to alloy at least some of the first portions and the second portions by solid-state diffusion. This second temperature can be moderately above the second melting point. In some embodiments, the heating may be provided by heating the ambient that contains the first and second substrates and the solder structures.

In still other embodiments, alloying may take place by liquid phase diffusion. Thus, in these embodiments, after the joining and/or positioning, the solder structures are heated to at least the first melting point. In some embodiments, a brief temperature spike to at least the first melting point may be provided by at least one heater that is contained in the second substrate and is adjacent the solder structures. In these embodiments, liquid state diffusion may be provided without the need to undesirably impact the positioning that already has been achieved.

Substrate packages according to embodiments of the invention can include a first substrate, a second substrate and a plurality of solder structures between the first and second substrates. The solder structures include a first portion that is attached to the second substrate and that has a first melting point, and a second portion that is attached to the first substrate and that has a second melting point that is lower than the first melting point. A heater may be included in the second substrate that is adjacent the solder structures, and the first substrate can be free of heaters therein.

Finally, systems for attaching a first substrate to a second substrate using solder structures having at least two portions with different melting points can include a heating system, a controller that is configured to heat the solder structures to the first temperature, and an actuator that can attach the first substrate to the second substrate while the second portions are melted. The controller also can be configured to heat the solder structures to the second temperature, after the first and second substrates are attached to one another. Accordingly, attachment may be made at relatively low temperatures, without the need to use high creep rate solders.

### BRIEF DESCRIPTION OF THE DRAWINGS

FIG. 1 is a flowchart of operations for attaching a first substrate to a second substrate according to embodiments of the invention.

FIGS. 2A-2C′ are cross-sectional views of first substrates and second substrates being attached during intermediate steps according to embodiments of the present invention.

FIGS. 3A and 3B graphically illustrate temperature versus time profiles for attaching a first substrate to a second substrate according to embodiments of the present invention.

FIG. 4 is a cross-sectional view of other second substrates and solder structures including a barrier layer according to embodiments of the present invention.

FIG. 5 is a schematic diagram of systems and methods for attaching a first substrate to a second substrate according to embodiments of the present invention.

### DETAILED DESCRIPTION OF PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the relative sizes of regions may be exaggerated for clarity. It will be understood that when an element such as a layer, region or substrate is referred to as being “on” another element, it can be directly on the other element or intervening elements may also be present. In contrast, when an element is referred to as being “directly on” another element, there are no intervening elements present.

Embodiments of the present invention may arise from realizations that if a solder structure is formed of two or more portions with an appropriate hierarchy of melting temperatures, also referred to herein as a melting point (MP), it is possible to melt an upper portion adjacent a first substrate without melting a lower portion adjacent a second substrate, to allow joining and/or positioning. At a later time, the temperature can be raised, for example, to the melting point of the lower portion, causing at least some of the two portions to alloy. The alloy can have a melting point that is greater than that of the upper portion. Thus, the melting point of the alloy can be increased and the creep rate can be reduced. In some embodiments, alloying can take place by diffusion from the solid-state at a temperature that can be moderately above the melting point of the upper portion. In other embodiments, alloying can take place by diffusion from the liquid state using a brief temperature spike to at least the melting point of the lower portion.

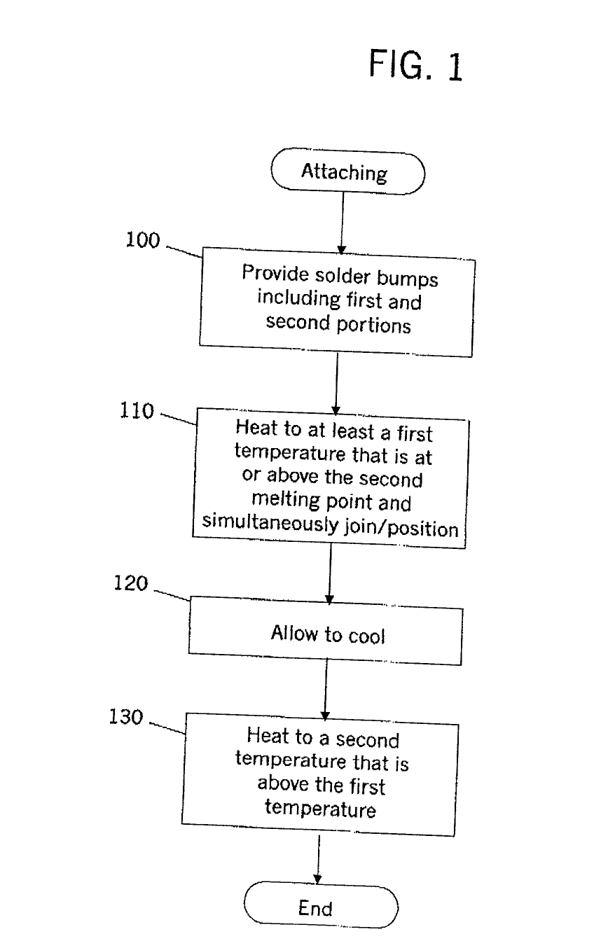

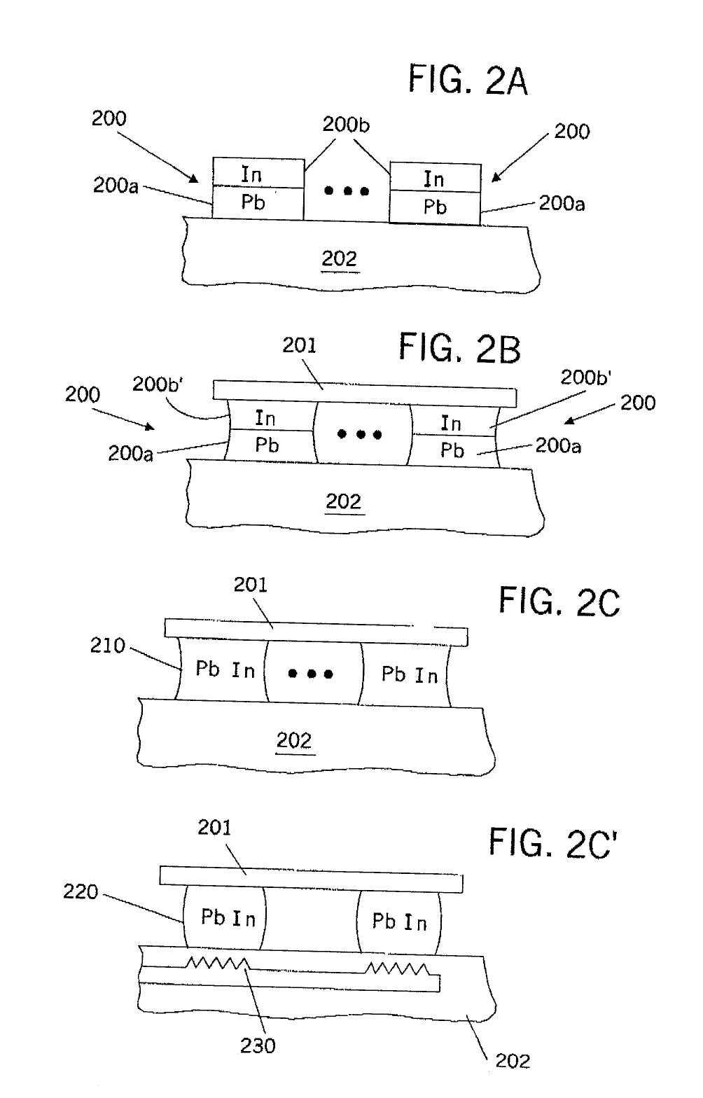

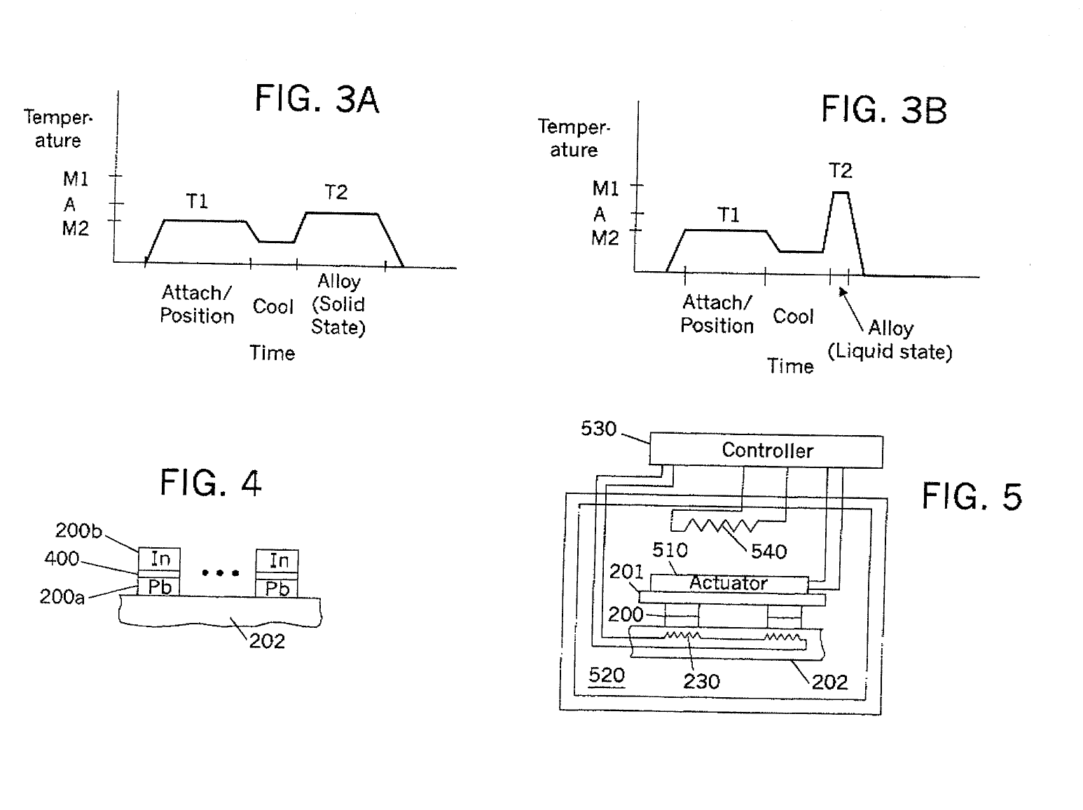

FIG. 1 is a flowchart of operations for attaching a first substrate to a second substrate according to embodiments of the invention. The operations of FIG. 1 will be explained with reference to FIGS. 2A-2C′, which are cross-sectional views of first substrates and second substrates being attached to one another during intermediate steps, and with respect to FIGS. 3A and 3B, which graphically illustrate temperature versus time profiles for attaching a first substrate to a second substrate according to embodiments of the present invention.

Referring now to FIG. 1 and FIG. 2A, at Block 100 of FIG. 1, a plurality of solder structures 200 is provided, for example, on a second substrate 202. The solder structures 200 include a first portion 200a adjacent the second substrate 202 that has a first melting point M1 and a second portion 200b remote from the second substrate 202 that has a second melting point M2 that is lower than the first melting point M1. In one example, the first portions 200a can consist of pure lead having a first melting point M1 of about 327° C. The second portions 200b can consist of pure indium with a melting point M2 of 156° C. However, it will be understood that other configurations of materials may be used. Moreover, more than two portions may be provided in the solder structures 200. In other embodiments, the solder structures may be provided on a second substrate. In still other embodiments, the first portions 200a may be provided on the first substrate 202 and the second portions 200b may be provided on the second substrate. For simplicity, FIGS. 2A and 4 illustrate the first and second portions 200a and 200b on the first substrate 202 only.

The fabrication of solder structures having at least two portions with differing melting points is well known to those having skill in the art. Many examples are provided in application Ser. No. 09/576,477 to the present inventor Rinne, entitled Trilayer/Bilayer Solder Bumps and Fabrication Methods Therefor, assigned to the assignee of the present application, the disclosure of which hereby incorporated herein by reference in its entirety as if set forth fully herein. Moreover, as shown in FIG. 2A, the solder structure may comprise a solder bump structure. However, it also will be understood that the first portions 200a may be provided as part of an underbump metallurgy structure as described in the above-cited application Ser. No. 09/576,477. In other embodiments, the first portions 200a may be provided as part of a solder reservoir or redistribution routing connector, as described, for example, in U.S. Pat. No. 5,892,179 to Rinne, entitled Solder Bumps and Structures for Integrated Redistribution Routing Conductors, the disclosure of which hereby incorporated herein by reference in its entirety as if set forth fully herein. In other embodiments, the first portions 200a may be provided by an external wire that can be fed into the melt of the solder until a desired concentration is achieved. Other embodiments of solder structures having multiple portions with different melting points also may be provided.

Referring again to FIG. 1 and referring to FIG. 2B, at Block 110, the solder structures 200 are heated to a first temperature T1 that is at or above the second melting point M2, but is below the first melting point M1. Thus, the second portions 200b are melted. Simultaneous with this heating, a first substrate 201 is attached to the melted second portions 200b′ while they are melted. Positioning of the first substrate 201 relative to the second substrate 202 also may be performed using, for example, conventional pick-and-place or other attachment/micromanipulator systems and methods. It will be understood that the first temperature TI need not be constant, but rather can vary.

FIGS. 3A and 3B graphically illustrate time/temperature profiles according to embodiments of the invention. Embodiments of Block 110 and FIG. 2B also are illustrated in FIGS. 3A-3B, wherein an “attach/position” time interval at a temperature T1 that is at least M2 but less than M1 is used to attach and position the first and second substrates 201 and 202 relative to one another. It will be understood by those having skill in the art that the first temperature T1 preferably is below an alloy temperature A that represents a temperature below which little, if any, solid-state diffusion of the constituents of the first and second portions 200a and 200b, respectively, take place. For example, when the first portion 200a consists of pure lead and the second portion 200b consists of pure indium, the alloy temperature A can be only moderately above the melting point of pure indium, such as about 156.6° C.

Still referring to FIGS. 1, 2B, 3A and 3B, in some embodiments, the solder bumps 200 are heated to exactly the melting point M2 of the second portions 200b, so that temperatures that are higher than needed need not be used during the attach/positioning interval. In other embodiments, temperatures above the second melting point M2 that are lower than the first melting point M1 of the first portions 200a may be used.

It also will be understood that, in some embodiments, the solid-state diffusion rate may be excessively high, so that the dwell time above the liquidus, denoted by the attach/position time intervals of FIGS. 3A and 3B, may be too short for the positioning process. As illustrated in FIG. 4, in some embodiments, a thin diffusion barrier 400 such as a layer comprising nickel that is about 250 nm thick, may be formed between the first and second portions 200a and 200b, respectively. Since the barrier layer 400 can be thin, it can be quickly absorbed into the solder structure, but can effectively raise the alloy temperature A, thus providing sufficient delay for attachment and/or positioning.

Referring again to FIG. 1, at Block 120, the solder bumps 200 are allowed to cool to below the second melting point M2, as shown, for example, in FIGS. 3A and 3B by a “cool” time interval. The solder bumps 200 thereby solidify. It will be understood that this time interval may be minimized or eliminated in some embodiments. It also will be understood that cooling may be obtained by cessation of heating of Block 110 and/or by active cooling. Cooling need not take place all the way to room temperature, but merely may take place to below the second melting point M2.

Finally, referring again to FIG. 1, at Block 130, the solder bumps 200 are heated to a second temperature T2 that is above the first temperature T1, to alloy at least some of the first portions 200a and the second portions 200b. It will be understood that the second temperature T2 need not be constant, but rather can vary. It also will be understood that some of the first and/or second portions may remain after alloying or the solder structure may be completely alloyed. Moreover, all the solder structures need not be alloyed uniformly. Alloying of Block 130 can increase the melting point above the melting point M2 of the second portions, and thereby can reduce the creep rate of the solder structure that is formed thereby.

Various embodiments of alloying operations of Block 130 now will be described. Some embodiments use solid-state alloying, as described in FIGS. 2C and 3A. Other embodiments use liquid state alloying, and are described in FIGS. 2C′ and 3B.

Referring now to FIGS. 2C and 3A, in solid-state alloying, the solder bumps 200 are heated to at least the temperature A that alloys the first and second portions 200a and 200b thereof, but below the first melting point M1 of the first portions 200a. Thus, as shown in FIG. 2C, a new solder structure 210 is formed that is at least partially alloyed while remaining in the solid phase. In FIG. 2C, complete alloying is shown. In some embodiments, this solder structure 210 can be a lead-indium alloy that has a higher melting point than pure indium, but has a lower creep rate than pure indium. For example, when the alloy is 30Pb-70In, the melting point may be 200° C., as shown by a chart at Page 855 of Hanson, Constitution of Binary Alloys, McGraw-Hill Book Company, New York, 1958, the disclosure of which is hereby incorporated herein by reference in its entirety as if set forth fully herein.

In embodiments of FIG. 3A, the time interval in which the operations of Block 130 are performed, shown in FIG. 3A as “alloy (solid-state)”, is less than the attach/position time interval. Stated differently, in some embodiments, the time for attaching and positioning at the first temperature T1 is sufficiently long to attach and position the first substrate relative to the second substrate, whereas the solid-state alloy time at the second temperature T2 only is long enough to allow the solid-state alloying to take place. Moreover, FIG. 3A illustrates embodiments wherein alloying takes place at the alloying temperature A. However, higher temperatures above A but less than M1 may be used.

Referring to FIGS. 2C′ and 3B, liquid state alloying may take place by spiking the temperature to at least the first melting point M1. This time interval at the second temperature T2 is shown in FIG. 3B as “alloy (liquid state)”. In some embodiments, the spiking at the second temperature T2 takes places for a time that only is sufficient to cause liquid phase alloying, and thereby form the solder bumps 220 of FIG. 2C′, but that preferably is not long enough to heat the first and second substrates 201 and 202 to cause thermal mismatches to distort the positioning of the first substrate 201 on the second substrate 202. In some embodiments, the liquid state alloying may take place over a time interval of between about 20 milliseconds to about 60 seconds.

Moreover, as illustrated in FIG. 2C′, in some embodiments, the temperature of the second portions 200a is increased to at least the first melting point M1 thereof using one or more heaters 230 within the second substrate 202. Thus, the temperature of the first portions 200a can be raised to at least the first melting point M1 thereof, without the need to adversely impact the temperature of the remaining components. Similar to FIG. 3A and FIG. 3B, in some embodiments, the liquid state alloy time interval is less than the attach/position time interval. Moreover, partial or complete alloying may take place. Finally, after the operations of Block 130 are performed, the solder bumps are allowed to cool, by passive and/or active cooling.

FIG. 5 is a schematic diagram of systems and methods for attaching a first substrate to a second substrate according to embodiments of the present invention. As shown in FIG. 5, at least one ambient heater 540 may be used to heat an ambient 520 in which the first and second substrates 201 and 202, and the solder bumps 200 are contained, for example during attach/position operations (Block 110 of FIG. 1). In some embodiments, the ambient heater 540 also may be used to heat the ambient 520 to at least the alloy temperature A for solid-state alloying (Block 130 of FIG. 1 and FIG. 2C). Moreover, in other embodiments, the ambient heater 540 may be used to heat the ambient to at least the melting point M1 of the first portions for liquid state alloying (Block 130 of FIG. 1 and FIG. 2C′). Still referring to FIG. 5, at least one substrate heater 230 may be included in the second substrate 202. In some embodiments, the substrate heater may be used to heat the solder bumps 200 to the second melting temperature M2 in the attach/position operation (Block 110 of FIG. 1). In other embodiments, the substrate heaters 230 also may be used to perform solid-state or liquid state alloying (Block 130 of FIG. 1). An actuator 510 such as a conventional pick-and-place mechanism and/or manipulator, may be used to attach and position the first substrate 201 relative to the second substrate 202, while the second portions 200b are melted.

It will be understood that in some embodiments of solid-state alloying, for example as shown in FIGS. 2C and 3A, the ambient heater 540 is used during the attach/position time interval and the ambient heater 540 also is used during the solid-state alloy time interval. Moreover, in some embodiments of liquid state alloying of FIGS. 2C′ and 3B, the ambient heater 540 is used during the attach/position time interval, whereas the substrate heater 230 is used during the liquid state alloy time interval.

Still referring to FIG. 5, a controller 530 can be used to control the ambient heater 540, the substrate heater 230 and/or the actuator 510, to perform any of the operations that were described above. The controller may use a combination of hardware and/or software. Two or more separate controllers also may be used. Accordingly, embodiments of the invention can use low melting point solders for attachment and/or positioning, and can convert to a higher melting point solder with a lower creep rate thereafter.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A method of attaching a first substrate to a second substrate, comprising:
providing a plurality of solder structures that include a first portion adjacent the second substrate that has a first melting point and a second portion adjacent the first substrate that has a second melting point that is lower than the first melting point; then
heating the solder structures to a first temperature that is at or above the second melting point but below the first melting point, to melt the second portions;
simultaneous with the heating the solder structures to at least the first temperature, attaching the first substrate to the second substrate while the second portions are melted; and then
heating the solder structures to a second temperature that is above the first temperature to alloy at least some of the first portions and the second portions.

2. A method according to claim 1 wherein the following is performed between the attaching the first substrate to the second substrate while the second portions are melted and the heating the solder structures to the second temperature:
allowing the solder structures to cool to below the second melting point.

3. A method according to claim 1:
wherein the heating the solder structures to the first temperature is performed for a first time interval; and
wherein the heating the solder structures to the second temperature is performed for a second time interval that is less than the first time interval.

4. A method according to claim 3 wherein the first time interval is sufficiently long to allow the first substrate to be attached to the second substrate and positioned relative to the second substrate, and wherein the second time interval only is sufficiently long to alloy at least some of the first portions and the second portions.

5. A method according to claim 1:
wherein the heating the solder structures to the first temperature is performed by heating an ambient that contains the first and second substrates and the solder structures to the first temperature; and
wherein the heating the solder structures to the second temperature is performed by activating at least one heater in the second substrate that is adjacent the solder structures.

6. A method according to claim 1 wherein the heating the solder structures to the first temperature comprises heating the solder structures to the second melting point.

7. A method according to claim 1 wherein the heating the solder structures to the second temperature comprises heating the solder structures to a temperature that alloys at least some of the first portions and the second portions by solid state diffusion.

8. A method according to claim 1 wherein the heating the solder structures to the second temperature comprises heating the solder structures to at least the first melting point to alloy at least some of the first portions and the second portions by liquid state diffusion.

9. A method according to claim 8:
wherein the heating the solder structures to the first temperature is performed for a first time interval; and
wherein the heating the solder structures to the second temperature is performed for a second time interval that is less than the first time interval.

10. A method according to claim 9:
wherein the heating the solder structures to the first temperature is performed by heating an ambient that contains the first and second substrates and the solder structures to the first temperature; and
wherein the heating the solder structures to the second temperature is performed by activating at least one heater in the second substrate that is adjacent the solder structures.

11. A method according to claim 7 wherein the heating the solder structures to the first temperature comprises heating the solder structures to the second melting point.

12. A method according to claim 1:
wherein the providing a plurality of solder structures comprises providing a plurality of solder structures on the second substrate that include a first portion adjacent the second substrate that has a first melting point, a second portion adjacent the first substrate that has a second melting point that is lower than the first melting point and a diffusion barrier between the first and second portions; and
wherein the heating the solder structures to at least the second temperature comprises heating the solder structures to the second temperature to alloy at least some of the first portions and the second portions across the diffusion barrier.

13. A method according to claim 1 wherein the first portion consists of lead and wherein the second portion consists of indium.

14. A substrate package comprising:
a first substrate;
a second substrate;
a plurality of solder structures between the first and second substrates, that include a first portion that is attached to the second substrate and that has a first melting point and a second portion that is attached to the first substrate and that has a second melting point that is lower than the first melting point.

15. A package according to claim 14 further comprising:
a heater in the second substrate that is adjacent the solder structures, the first substrate being free of heaters therein.

16. A package according to claim 14 further comprising:
a diffusion barrier between the first and second portions.

17. A package according to claim 14 wherein the first portion consists of lead and wherein the second portion consists of indium.

18. A system for attaching a first substrate to a second substrate, comprising:
a plurality of solder structures that include a first portion adjacent the second substrate that has a first melting point and a second portion adjacent the first substrate that has a second melting point that is lower than the first melting point;
means for heating the solder structures to a first temperature that is at or above the second melting point but below the first melting point, to melt the second portions, and for simultaneously attaching the first substrate to the second substrate while the second portions are melted; and
means for heating the solder structures to a second temperature that is above the first temperature to alloy at least some of the first portions and the second portions.

19. A system according to claim 18:
wherein the means for heating the solder structures to the first temperature is activated for a first time interval; and
wherein the means for heating the solder structures to the second temperature is activated for a second time interval that is less than the first time interval.

20. A system according to claim 19 wherein the first time interval is sufficiently long to allow the first substrate to be attached to the second substrate and positioned relative to the second substrate, and wherein the second time interval only is sufficiently long to alloy at least some of the first portions and the second portions.

21. A system according to claim 18:
wherein the means for heating the solder structures to the first temperature comprises means for heating an ambient that contains the first and second substrates and the solder structures to the first melting temperature; and
wherein the means for heating the solder structures to the second temperature comprises at least one heater in the second substrate that is adjacent the solder structures.

22. A system according to claim 18 wherein the means for heating the solder structures to the first temperature comprises means for heating the solder structures to the second melting point.

23. A system according to claim 18 wherein the means for heating the solder structures to the second temperature comprises means for heating the solder structures to a temperature that alloys at least some of the first portions and the second portions by solid state diffusion.

24. A system according to claim 18 wherein the means for heating the solder structures to at least the second temperature comprises means for heating the solder structures to at least the first melting point to alloy at least some of the first portions and the second portions by liquid state diffusion.

25. A system according to claim 18 further comprising:
a diffusion barrier between the first and second portions; and
wherein the means for heating the solder structures to at least the second temperature comprises means for heating the solder structures to the second temperature to alloy at least some of the first portions and the second portions across the diffusion barrier.

26. A system according to claim 18 wherein the first portion consists of lead and wherein the second portion consists of indium.

27. A system for attaching a first substrate to a second substrate, comprising:
a plurality of solder structures that include a first portion adjacent the second substrate that has a first melting point and a second portion adjacent the first substrate that has a second melting point that is lower than the first melting point;
a heating system that is configured to heat the solder structures;
an actuating system that is configured to move the first substrate relative to the second substrate; and
a controller that is configured to activate the heating system to heat the solder structures to a first temperature that is at or above the second melting point but below the first melting point to melt the second portions, to control the actuating system to attach the first substrate to the second substrate while the second portions are melted and to activate the heating system to heat the solder structures to at least a second temperature that is above the first temperature to alloy at least some of the first portions and the second portions.

28. A system according to claim 27 wherein the controller also is configured to deactivate the heating system after attaching the first substrate to the second substrate, to thereby allow the solder structures to cool to below the second melting point.

29. A system according to claim 27:
wherein the controller also is configured to activate the heating system to heat the solder structures to at least the first temperature for a first time interval; and
wherein controller also is configured to activate the heating system to heat the solder structures to at least the second temperature for a second time interval that is less than the first time interval.

30. A system according to claim 29 wherein the first time interval is sufficiently long to allow the first substrate to be attached to the second substrate and positioned relative to the second substrate, and wherein the second time interval only is sufficiently long to alloy at least some of the first portions and the second portions.

31. A system according to claim 27 wherein the heating system comprises:
an ambient heater that is configured to heat an ambient that contains the first and second substrates and the solder structures to the first temperature; and
at least one heater in the second substrate that is adjacent the solder structures and that is configured to heat the solder structures to the second temperature.

32. A system according to claim 27 wherein the controller also is configured to activate the heating system to heat the solder structures to the second temperature to alloy at least some of the first portions and the second portions by solid state diffusion.

33. A system according to claim 27 wherein the controller also is configured to activate the heating system to heat the solder structures to at least the first melting point to alloy at least some of the first portions and the second portions by liquid state diffusion.

34. A system according to claim 27 further comprising:
a diffusion barrier between the first and second portions; and
wherein the controller also is configured to activate the heating system to heat the solder structures to at least the second temperature to alloy at least some of the first portions and the second portions across the diffusion barrier.

35. A system according to claim 27 wherein the first portion consists of lead and wherein the second portion consists of indium.
